(19) United States
(12) Patent Application Publication
(10) Pub. No.: US 2024/0199320 A1
(43) Pub. Date: Jun. 20, 2024

(54) Elasticized Trash Bag Assembly

(71) Applicant: Ashley Price, Arlington, TX (US)

(72) Inventor: Ashley Price, Arlington, TX (US)

(21) Appl. No.: 18/082,262

(22) Filed: Dec. 15, 2022

(51) Int. Cl. B65F 1/00; B65D 33/14; B65D 33/28

(52) U.S. Cl. CPC B65F 1/0026; B65D 33/14; B65D 33/28; B65F 1/002

(57) ABSTRACT

An elasticized trash bag assembly includes a trash bag that is positionable in a trash can. The trash bag has a lower portion that is comprised of a fluid impermeable material for storing trash. The trash bag has an upper portion that is comprised of a resiliently stretchable material. Thus, the upper portion is stretchable around a top of the trash can thereby facilitating the upper portion to compress around the trash can. An elastic band is integrated into the trash bag and the elastic band extends around the upper portion of the trash bag. The elastic band is stretchable around the top of the trash can thereby facilitating the elastic band to compress the trash bag around the trash can.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trash bag devices and more particularly pertains to a new trash bag device for compressing around a trash can.

### (2) Description of Related Art Including Information Disclosed Under 37 CFR 1.97 and 1.98

The prior art relates to trash bag devices.

### BRIEF SUMMARY OF THE INVENTION

An embodiment of the disclosure meets the needs presented above by generally comprising a trash bag that is positionable in a trash can. The trash bag has a lower portion that is comprised of a fluid impermeable material for storing trash. The trash bag has an upper portion that is comprised of a resiliently stretchable material. Thus, the upper portion is stretchable around a top of the trash can thereby facilitating the upper portion to compress around the trash can. An elastic band is integrated into the trash bag and the elastic band extends around the upper portion of the trash bag. The elastic band is stretchable around the top of the trash can thereby facilitating the elastic band to compress the trash bag around the trash can.

There has thus been outlined, rather broadly, the more important features of the disclosure in order that the detailed description thereof that follows may be better understood, and in order that the present contribution to the art may be better appreciated.

There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an elasticized trash bag assembly according to an embodiment of the disclosure.

FIG. 2 is an exploded perspective view of an embodiment of the disclosure.

FIG. 3 is a front view of an embodiment of the disclosure showing a trash bag being tied closed.

FIG. 4 is a cross sectional view taken along line 4-4 of FIG. 1 of an embodiment of the disclosure.

### DETAILED DESCRIPTION OF THE INVENTION

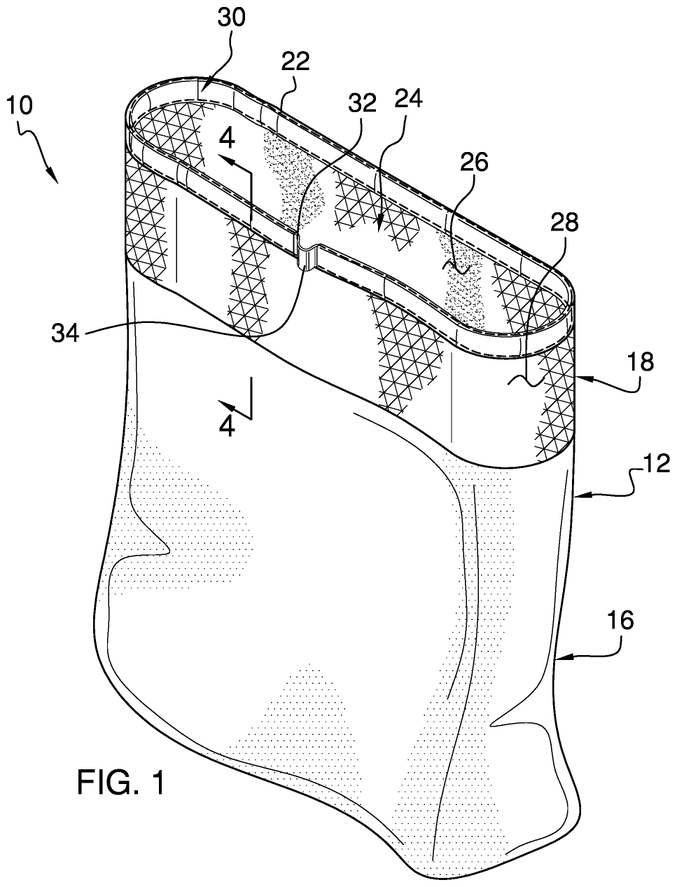

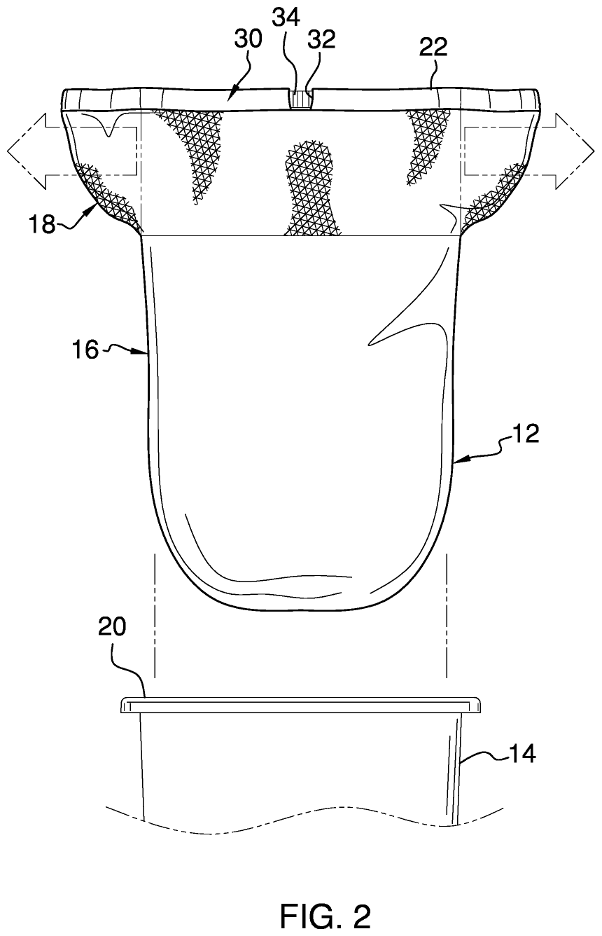

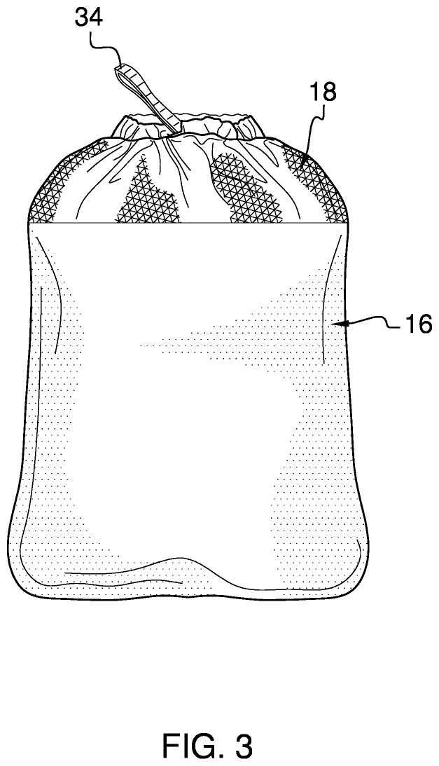

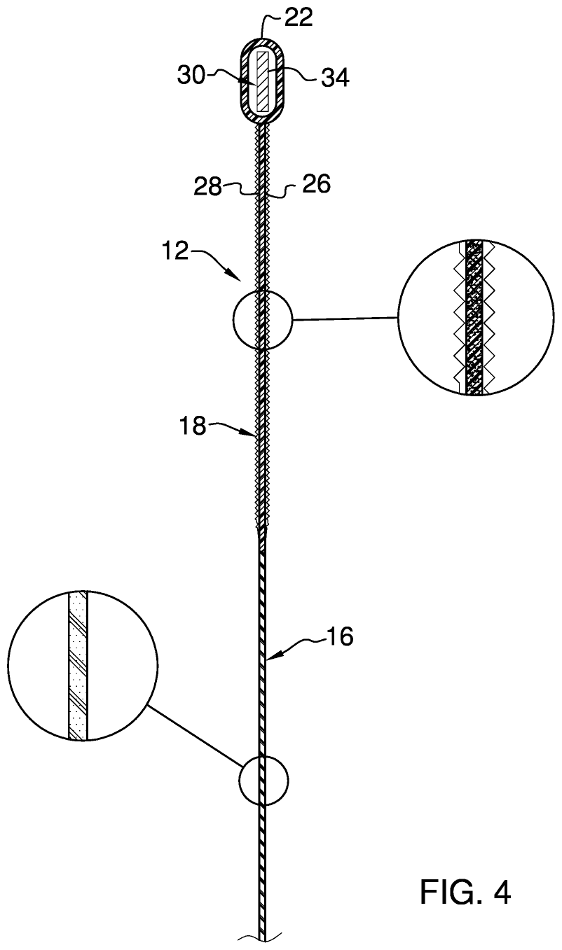

With reference now to the drawings, and in particular to FIGS. 1 through 4 thereof, a new trash bag device embodying the principles and concepts of an embodiment of the disclosure and generally designated by the reference numeral 10 will be described.

As best illustrated in FIGS. 1 through 4, the elasticized trash bag assembly 10 generally comprises a trash bag 12 is positionable in a trash can 14. The trash bag 12 has a lower portion 16 and an upper portion 18. The lower portion 16 is comprised of a fluid impermeable material, such as plastic or the like, for storing trash. The upper portion 18 is comprised of a resiliently stretchable material. Moreover, the upper portion 18 is stretchable around a top 20 of the trash can 14 thereby facilitating the upper portion 18 to compress around the trash can 14. In this way the trash bag 12 presents a neat and orderly appearance when the trash bag 12 is positioned in the trash can 14. Additionally, the trash bag 12 is infused with a chemical deodorant for concealing unpleasant odors associated with trash.

The trash bag 12 has a top edge 22 defining an opening 24 into the trash bag 12. The upper portion 18 of the trash bag 12 extends downwardly from the top edge 22 toward an intersection between the upper portion 18 and the lower portion 16. The upper portion 18 has an inside surface 26 and an outside surface 28, and a channel 30 is integrated into the upper portion 18. The channel 30 is positioned between the inside surface 26 and the outside surface 28, and the channel 30 is coextensive with the top edge 22 of the trash bag 12. The upper portion 18 has a band hole 32 extending into the channel 30. Each of the inside surface 26 and the outside surface 28 of the upper portion 18 is textured for enhancing gripping the upper portion 18. Additionally, the upper portion 18 may be infused with a chemical that changes colors when the chemical is exposed to moisture. In this way the upper portion 18 may facilitate a visual alert that the trash bag 12 has become filled with garbage.

An elastic band 34 is integrated into the trash bag 12. The elastic band 34 extends around the upper portion 18 of the trash bag 12. Moreover, the elastic band 34 biases the trash bag 12 into a closed condition. The elastic band 34 is stretchable around the top of the trash can 14 thereby facilitating the elastic band 34 to compress the trash bag 12 around the trash can 14. The elastic band 34 is positioned in the channel 30 in the upper portion 18 of the trash bag 12. Additionally, the elastic band 34 is accessible through the band hole 32 in the upper portion 18 for tightening the elastic band 34 and thusly closing the trash bag 12. In this way the elastic band 34 can be tied off to close the trash bag 12.

In use, the trash bag 12 is inserted into the trash can 14 and the upper portion 18 of the trash bag 12 is stretched around the top of the trash can 14 and drawn downwardly around the top of the trash can 14. The elastic band 34 and the resiliently stretchable properties of the upper portion 18 facilitate the trash bag 12 to tighten around the trash can 14. In this way the trash bag 12 can accommodate a variety of sizes of trash can 14s without needing to be tied off or otherwise tightened around the trash can 14. The elastic band 34 is gripped through the band hole 32 for removing the trash bag 12 from the trash can 14 as well as closing the trash bag 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An elasticized trash bag assembly being configured to conform to an outer surface of a trash can thereby facilitating a neater appearance, said assembly comprising:
a trash bag being positionable in a trash can, said trash bag having a lower portion and an upper portion, said lower portion being comprised of a fluid impermeable material for storing trash, said upper portion being comprised of a resiliently stretchable material, said upper portion being stretchable around a top of the trash can thereby facilitating said upper portion to compress around the trash can wherein said trash bag is configured to present a neat and orderly appearance when said trash bag is positioned in the trash can, said trash bag being infused with a chemical deodorant for concealing unpleasant odors associated with trash; and
an elastic band being integrated into said trash bag, said elastic band extending around said upper portion of said trash bag, said elastic band biasing said trash bag into a closed condition, said elastic band being stretchable around the top of the trash can thereby facilitating said elastic band to compress said trash bag around the trash can.

2. The assembly according to claim 1, wherein said trash bag has a top edge defining an opening into said trash bag, said upper portion of said trash bag extending downwardly from said top edge toward an intersection between said upper portion and said lower portion.

3. The assembly according to claim 1, wherein said upper portion has an inside surface and an outside surface, said upper portion having a channel being integrated therein, said channel being positioned between said inside surface and said outside surface, said channel being coextensive with a top edge of said trash bag.

4. The assembly according to claim 3, wherein said upper portion has a band hole extending into said channel.

5. The assembly according to claim 3, wherein each of said inside surface and said outside surface of said upper portion is textured for enhancing gripping said upper portion.

6. The assembly according to claim 4, wherein said elastic band is positioned in said channel in said upper portion of said trash bag, said elastic band being accessible through said band hole in said upper portion for tightening said elastic band and thusly closing said trash bag.

7. An elasticized trash bag assembly being configured to conform to an outer surface of a trash can thereby facilitating a neater appearance, said assembly comprising:
a trash bag being positionable in a trash can, said trash bag having a lower portion and an upper portion, said lower portion being comprised of a fluid impermeable material for storing trash, said upper portion being comprised of a resiliently stretchable material, said upper portion being stretchable around a top of the trash can thereby facilitating said upper portion to compress around the trash can wherein said trash bag is configured to present a neat and orderly appearance when said trash bag is positioned in the trash can, said trash bag being infused with a chemical deodorant for concealing unpleasant odors associated with trash, said trash bag having a top edge defining an opening into said trash bag, said upper portion of said trash bag extending downwardly from said top edge toward an intersection between said upper portion and said lower portion, said upper portion having an inside surface and an outside surface, said upper portion having a channel being integrated therein, said channel being positioned between said inside surface and said outside surface, said channel being coextensive with said top edge of said trash bag, said upper portion having a band hole extending into said channel, each of said inside surface and said outside surface of said upper portion being textured for enhancing gripping said upper portion; and
an elastic band being integrated into said trash bag, said elastic band extending around said upper portion of said trash bag, said elastic band biasing said trash bag into a closed condition, said elastic band being stretchable around the top of the trash can thereby facilitating said elastic band to compress said trash bag around the trash can, said elastic band being positioned in said channel in said upper portion of said trash bag, said elastic band being accessible through said band hole in said upper portion for tightening said elastic band and thusly closing said trash bag.
